(19) United States
(12) Patent Application Publication
(10) Pub. No.: US 2003/0206114 A1
(43) Pub. Date: Nov. 6, 2003

(54) Interface device for sti/bpsg EPD and real time control

(76) Inventors: Leping Li, Poughkeepsie, NY (US); James A. Gilhooly, Saint Albans, VT (US); Clifford O. Morgan III, Burlington, VT (US); Cong Wei, Poughkeepsie, NY (US); Werner Moser, Gebertingen (CH); Matthias Kutter, Staefa (CH); Joseph Knee, Cromwell, CT (US); Walter Imfeld, Hombrechtiken (CH); Bruno Greuter, Wolfhausen (CH); Heinz Stuenzi, Hombrechtiken (CH)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(21) Appl. No.: 09/942,418

(22) Filed: Aug. 30, 2001

Related U.S. Application Data
(63) Continuation of application No. 09/129,107, filed on Aug. 4, 1998, now abandoned.

(51) Int. Cl. H04Q 1/00

(52) U.S. Cl. 340/825

(57) ABSTRACT

An instrumentation device for controlling one or more instruments, wherein the instrumentation device having an interface which accepts at least three sets of inputs and transmits at least three sets of outputs, the interface capable of transmitting signals of different voltage between the individual inputs and individual outputs of the interface and wherein the interface is capable of accepting, translating and transmitting as one of the at least three sets of outputs, input from more than one set of the at least sets of three inputs.

### FIELD OF THE INVENTION

This invention is directed to semiconductor processing and more particularly to the device for real time communication between different devices of a system, where the different devices have different electrical characteristics.

### BACKGROUND OF THE INVENTION

In the semiconductor industry, critical steps in the production of integrated circuits are the selective formation and removal of films on an underlying substrate. Typical processing steps involve: (1) depositing a film, (2) patterning areas of the film using lithography and etching, (3) depositing a film which fills the etched areas, and (4) planarizing the structure by etching or chemical-mechanical polishing (CMP). Films are removed by any of several well-known methods, for example CMP, dry etching such as reactive ion etching (RIE), wet etching, electrochemical etching, vapor etching, and spray etching.

It is extremely important with removal of films to stop the process when the correct thickness has been achieved (the endpoint has been reached). With CMP, a film is selectively removed from a semiconductor wafer by rotating the wafer against a polishing pad (or rotating the pad against the wafer, or both) with a controlled amount of pressure in the presence of a chemically reactive slurry. Overpolishing (removing too much) of a film results in yield loss, and underpolishing (removing too little) requires costly rework (redoing the CMP process). Various methods have been employed to detect when the desired endpoint for removal has been reached, and the polishing should be stopped. Once the endpoint has been detected, the information must be communicated to the polisher to stop polishing. When the endpoint detection takes place at a location that is physically distant from the polisher, then the information may not automatically passed to the polisher. Additionally, if the to detector directly passes the information to the polisher then there must exist within the detector the means to communicate and operate at a current which would be compatible with existing types of polishers. Different vendors such as Ebara and IPEC make polishers that are not interchangeable, therefore, the detector should be able to process different types of information. Presently, there are no methods of communicating in real time the detection of the endpoint to other components the comprise a CMP endpoint detection system.

### SUMMARY OF THE INVENTION

It is therefore an object of the present invention to provide an apparatus for communicating the detection of an endpoint when removing a film of any type from another film.

It is another object of the present invention to provide real time communication of the detection of the endpoint when removing a film of any type from another film to other devices in the CMP endpoint detection system.

It is yet another object of the present invention to provide a device that enables automatic communication between the polisher and the physically distant command and control unit in a CMP endpoint detection system so that the polisher reacts in real time to the detection of an endpoint condition.

In accordance with the above listed and other objects, An instrumentation device for controlling one or more instruments, wherein the instrumentation device has an interface which accepts at least three sets of inputs and transmits at least three sets of outputs, the interface capable of transmitting signals of different voltage between the individual inputs and individual outputs of the interface and wherein the interface is capable of receiving, translating and sending as one of the at least three sets of outputs, input from more than one set of the at least sets of three inputs is described.

### DETAILED EMBODIMENT

There exists a need for interface devices which communicate between different components in a system which have a plurality of electrical inputs and outputs. The instant interface device is described in the context of chemical-mechanical polishing merely as a specific example, and is not meant to limit applicability of the invention to semiconductor technology. Those skilled in the art will understand that the invention is broadly applicable to any process in which it is desirable to communicate between different components in a system which have a plurality of electrical inputs and outputs where signal conditioning may be necessary.

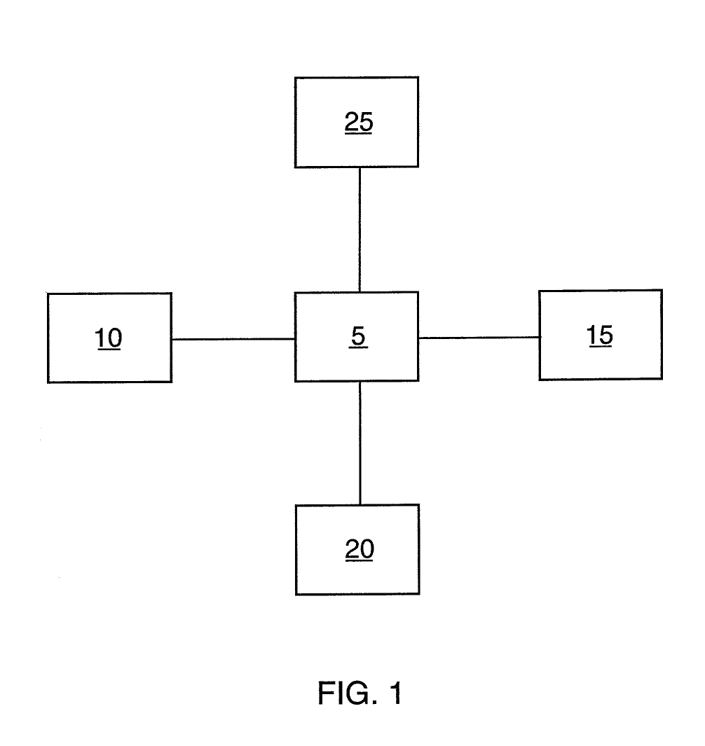

As an example, FIG. 1 identifies a CMP system, where the interface device, 5, in communication with four other devices, a polisher, 10, a control computer, 15, an analyzer, 20 and a system status stack lighting array, 25. In the example shown in FIG. 1 the analyzer, 20, is a chemiluminescence detection apparatus, like the one described in Attorney Docket no. HQ9-98-047 (CLD), Chemiluminescence Detection Apparatus to Li et al. Each of the devices in communication with the interface device sends and receives information. The interface device must be capable of converting the electrical property sent to or received from any individual device. Generally, the interface would be able to accommodate and condition inputs and outputs with dramatically different voltages. In a preferred embodiment, the interface would be able to adapt to voltages of 230 and 115 VAC and 100 VAC. The adaptation can be facilitated by jumper wires, fuses, rectifiers and capacitors.

Details of the communication provided between the interface and each of the other devices listed above, for a preferred embodiment is given herein:

a) Interface and Polisher

The interface should detect a start signal from the polisher. The Signal would be conditioned if necessary and transmitted to the control computer. The conditioning might include converting either an active +24V or active close (0 resistance) to a voltage of +5V or open circuit (infinite resistance) or a 0V signal to an ADC input of a data acquisition card in the control PC. This 5V signal is called EPP, which transmits a signal to the control program to start monitoring and controlling the polishing process. Another signal sent to the polisher and communicated by the interface is the EPD signal. The EPD signal tell the polisher to stop (or end) polishing.

b) Interface and Computer

The computer would received the conditioned start signal from the interface. This signal would trigger the computer to start collecting data from previously identified collection points, like the CLD. The computer would collect and analyze the data until a stop polishing condition is satisfied. The computer would then send a stop signal to the interface. The interface would then condition the signal, if necessary, and send the conditioned stop signal to the polisher. The conditioning of the signal will depend on the type of polisher being used. Additionally, the computer may generate auxiliary signals which, for reasons such as control robustness, prevent the polisher from running. The interface would transmit all such auxiliary signals to the appropriate other devices.

c) Interface and the CLD

The CLD communicates the following information to and from the interface as shown in Table I.

| Signal | Type | Notes |
|---|---|---|
| Analog Signal1 | 0-20 mA | Monitor signal translated into |
| | | 0-10 V |
| Analog Signal2 | 0-20 mA | Monitor signal translated into |
| | | 0-10 V |
| AGND | Analog Ground | |
| DGND | Digital Ground | |
| EPP | Dig. Input, | Polisher start |
| AAC | Dig. Input, | Acoustic alarm control |
| MMC1 | Dig. Input, | Maintenance mode control 1 |
| MMC2 | Dig. Input, | Maintenance mode control 2 |
| D1 | Dig: Out open collector, | Translated into 5 V active |
| | | high |
| D2 | Dig. Out open collector, | Active-LED on |
| D3 | Dig. Out open collector, | Active-LED on |
| D4 | Dig. Out open collector, | Reserved, no LED |

There are twelve communication points from/to the CLD to the interface. Two analog 0-20 mA signals, which are conditioned to a signal of 0-10V. Preferably, the condition is performed using a 500 ohm resistor. The conditioned signals are eventually sent to the computer to indicate the level of chemical concentration. As stated earlier, the EPP signal tells the CLD that the polisher has started polishing. MMC1 and MMC2 are present in a preferred embodiment to signal the CLD to close its inlet valve for maintenance. The MMC mode may be requested by either the CLD or the computer, or directly from a probe control box. The AAC is optional, but present in a preferred embodiment. The AAC is a signal that triggers a buzzer on the CLD when hardware related warning or error situation occurs. The buzzer is also used as an acoustic indication by the control software used for process control by the computer.

d) Interface and Status Light Stack

The interface converts the status signal from CLD prior to transmitting it to the status light stack, which gives a clear visual indication of the system status. This enables distance awareness of the system status.

In a preferred embodiment, the interface would communicate the status of the CLD to the computer and status light stack. Table II shows output that the interface receives from or sends to the CLD.

| ALARM | MMC1 | D1 | D2 | D3 | INDICATION |
|---|---|---|---|---|---|
| 0 | 0 | 1 | 1 | 1 | Start Up |
| 0 | 0 | 0 | 1 | 1 | OK, ready |
| 1 | X | 1 | 0 | 1 | Error |
| 0 | 0 | 0 | 0 | 1 | Warning |
| 0 | 1 | 1 | 1 | 0 | Maintenance |
| 0 | 0 | 0 | 1 | 0 | Calibration |

As shown in Table II, when AAC is active, there is an error or warning state and when the MCC 1 or 2 is active then the CLD is in maintenance mode. When the AAC or MMC 1 or 2 are inactive, then the D1-D3 outputs determine the state of the CLD which is transmitted to the interface. The outputs D1-D3 on/off combinations determine the state of the CLD which is transmitted to the interface. When the CLD is ready to operate, the combination of D1, D2,D3 is 0,0,1. The meanings of various on/off combinations are listed in Table 2.

It should be noted that there could be additional hardware and possibly software/firmware present in the interface. For example, there are a plurality of optical isolators. Also, there would be a switching means to allow the interface to accept inputs from and deliver output to active high and active low device, depending upon the type of the polisher selected. The interface would preferably display the status of all of the different devices that the interface is in communication with. In a more preferred embodiment, the displays would be LEDs and the interface would display the statuses of the polisher selector, polisher start, polisher stop and the CLD operating condition.

In summary, an apparatus has been described which is capable of communicating between different devices and is also capable of conditioning electrical inputs and outputs such that different devices with different electrical characteristics can operate in the same system.

While the invention has been described in terms of specific embodiments, it is evident in view of the foregoing description that numerous alternatives, modifications and variations will be apparent to those skilled in the art. Thus, the invention is intended to encompass all such alternatives, modifications and variations which fall within the scope and spirit of the invention and the appended claims.

What is claimed is:

1. An instrumentation device for controlling one or more instruments, wherein the instrumentation device comprising:
an interface which accepts at least three sets of inputs and transmits at least three sets of outputs, the interface capable of transmitting signals of different voltage between the individual inputs and individual outputs of the interface and wherein the interface is capable of accepting, translating and transmitting as one of the at least three sets of outputs, input from more than one set of the at least sets of three inputs.

2. The device according to claim 1, wherein at least one of the at least three sets of inputs is the output from a means for analyzing.

3. The device according to claim 2, wherein the analyzing means is a chemilumenescence detection apparatus (CLD) and at least one of the at least three sets of outputs of the device is an input to the CLD.

4. The device according to claim 3, wherein the device translates between a signal measured in mA and a signal measured in volts.

5. The device according to claim 4, wherein the interface translates between a signal of at least about 0 mA and at most about 20 mA and a signal of at least about 0V and at most about 10 V.

6. The device according to claim 5, wherein the interface also translates at least one of the at least three outputs to a 5V signal.

7. The device according to claim 1, wherein at least one of the set of at least three inputs is the output of a computer and at least one of the set of at least three outputs of the device is the computer.

8. The device according to claim 7, wherein the device translates between at least two signal having a first and second voltage.

9. The device according to claim 8 wherein the first voltage is about 5V and the second voltage is about 24V.

10. The device according to claim 1 wherein at least one of the at least three inputs is the output from, and at least one of the at least three outputs is the input to a CMP polisher.

11. The device according to claim 10, wherein the device translates between at least two signal having a first and second voltage.

12. The device according to claim 11 wherein the first voltage is about 5V and the second voltage is about 24V.

13. The device according to claim 1 wherein the device provides optical isolation between the instruments providing inputs and outputs to the device.

14. An instrumentation device for controlling one or more instruments, wherein the instrumentation device comprises:
a computer, having at least one set of computer input and at least one set of computer output;
an analyzer, having at least one set of analyzer input and at least one set of analyzer output;
a status light set, having at least two lights;
a polisher, having at least one set of polisher input and one set of polisher output and
an interface which accepts three sets of inputs and transmits four sets of outputs, wherein at least one of the three sets of inputs is the output from the computer, at least one of the three sets of inputs from the analyzer, at
least one of the three sets of inputs is from the polisher, at least one of the four sets of outputs is to the computer, at least one of the four sets of outputs is to the analyzer, at least one of the four sets of outputs is to the status light set and at least one set of outputs is to the polisher and wherein the interface is capable of translating individual inputs between two signals having a first and second voltage.

15. An instrumentation device for controlling one or more instruments, wherein the instrumentation device comprises:
an interface which accepts three sets of inputs and transmits four sets of outputs, wherein at least one of the three sets of inputs is the output from a computer, at least one of the three sets of inputs is from an analyzer, at least one of the three sets of inputs is from a polisher, at least one of the four sets of outputs is to the computer, at least one of the four sets of outputs is to the analyzer, at least one of the four sets of outputs is to the status light set and at least one set of outputs is to the polisher and wherein the interface is capable of translating individual inputs between two signals having a first and second voltage.
